(19) United States
(12) Patent Application Publication
(10) Pub. No.: US 2018/0156423 A1
(43) Pub. Date: Jun. 7, 2018

(54) ADJUSTABLE WALL WASHING ILLUMINATION ASSEMBLY

(71) Applicant: Lumenpulse Lighting Inc., Montreal (CA)

(72) Inventor: Daniel E. Murby, Medfield, MA (US)

(73) Assignee: Lumenpulse Lighting Inc., Montreal (CA)

(21) Appl. No.: 15/370,597

(22) Filed: Dec. 6, 2016

(51) Int. Cl. F21V 14/06; F21V 5/04; F21V 17/12; F21S 8/02

(52) U.S. Cl. CPC F21V 14/06; F21S 8/026; F21V 17/12; F21V 5/04

(57) ABSTRACT

A lighting fixture for providing wall washing illumination to a surface includes a fixture housing having a lens mounted at one end. The light is provided through the lens. The lens is mounted in two slots such that the lens can be moved along a primary axis of the fixture and an angle of the lens with respect to the primary axis can be changed within a predetermined range of angles.

### FIELD OF THE INVENTION

The disclosure relates to vertical plane illumination design applications where target vertical planes, i.e., walls vary in dimension, location, etc., and a variety of even illumination results are desired.

### BACKGROUND OF THE INVENTION

When providing light to an area, specifically a room with large expanses of walls, there are many approaches to the locations and types of light fixtures that can be used to provide the desired lighting effects. One technique, referred to as wall washing, is typically used to light flat walls in order to provide a nice, even distribution of light from floor to ceiling, bringing one's attention to a large, smooth vertical surface.

Lighting fixtures, in order to be the most effective for wall washing applications, i.e., to maximize even illumination, need to be installed to a specific, fixed design specification for optimal performance in the given location. Unlike other wall lights, wall washing fixtures are designed to direct light at a wall when either surface-mounted on the ceiling, recessed into the ceiling, or as uplighting surface-mounted to the floor, or recessed into the floor rather than mounted to the target wall itself.

In some situations, however, the lighting design applications and install scenarios may prevent a wall washing lighting fixture from being installed in the correct position for optimal performance, e.g., the amount of available set back from the target wall may be insufficient. This is especially relevant with track lighting where the track may have to be in a specific, fixed location. Accordingly, the location may not adhere to a manufacturer's wall wash guidelines for the specified light fixture and the results may not be optimal.

This problem is typically solved by providing custom discrete versions of a light fixture based on the application or re-installing the fixture in the correct location. These efforts, however, incur disruption, added cost and unexpected changes to the overall design as well as limits the flexibility to adapt to new spaces, layouts or building remodeling, e.g., art gallery changes or retail display changes.

What is needed, therefore, is a lighting design solution that is able to provide wall washing to the target wall where multiple dimensions, locations or other aspects of the target plane, or overall area, can be accommodated by a single lighting fixture design.

### SUMMARY

According to one aspect of the disclosure, an optical system maximizes even illumination of a vertical plane in a variety of changing applications based on the vertical plane's, i.e., a wall's, dimensions, target area, setback, fixture orientation, etc. Additionally, this system retains a fixture's aesthetic by keeping all optical components inside the fixture housing, i.e., without breaking the plane of the fixture aperture which also improves visual comfort by reducing glare.

In one aspect, a lighting fixture portion comprises a fixture housing having a longitudinal axis, a proximal end and a distal opening at a distal end. First and second longitudinal slots are defined in the fixture housing and the first and second longitudinal slots are parallel to the longitudinal axis of the fixture housing. In addition, a lens is slidably coupled to the first and second slots.

In one implementation, first and second pins are coupled to the lens through a respective slot in the fixture housing.

In another aspect, a lighting fixture comprises a fixture housing having a longitudinal axis, a proximal end, a distal end and an opening provided at the distal end. A first slot, having a first predetermined slot length oriented parallel to the longitudinal axis, is defined in the fixture housing. A second slot, having a second predetermined slot length oriented parallel to the longitudinal axis, is defined in the fixture housing. The second slot is located opposite the first slot about a periphery of the fixture housing and a lens is movably coupled to the first and second slots.

In yet another aspect, a lighting fixture comprises a housing having a proximal end and a distal opening at a distal end, a lens and means for slidably and rotatably coupling the lens to the housing.

### BRIEF DESCRIPTION OF THE DRAWINGS

Various implementations of at least one aspect of the present disclosure are discussed below with reference to the accompanying Figures. It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element. Further, where considered appropriate, reference numerals may be repeated among the drawings to indicate corresponding or analogous elements. For purposes of clarity, however, not every component may be labeled in every drawing. The Figures are provided for the purposes of illustration and explanation and are not intended as a definition of the limits of the aspects of the disclosure. In the Figures:

FIGS. 1-A and 1-B are exploded, perspective views of one aspect of the lighting fixture of the present disclosure;

FIG. 2 is an exploded, perspective view of a portion of the lighting fixture of FIGS. 1-A and 1-B;

FIG. 3 is a cutaway, perspective view of the lighting fixture of FIGS. 1-A and 1-B;

FIG. 4 is a partially cutaway, perspective view of the lighting fixture of FIGS. 1-A and 1-B;

FIG. 5 is a perspective view of the lighting fixture of FIGS. 1-A and 1-B;

FIGS. 6-1 AND 6-2 are partially cutaway, perspective views of the lighting fixture of FIGS. 1-A and 1-B installed in a location;

FIG. 7 is a side view of a lens of one aspect of the present disclosure; and

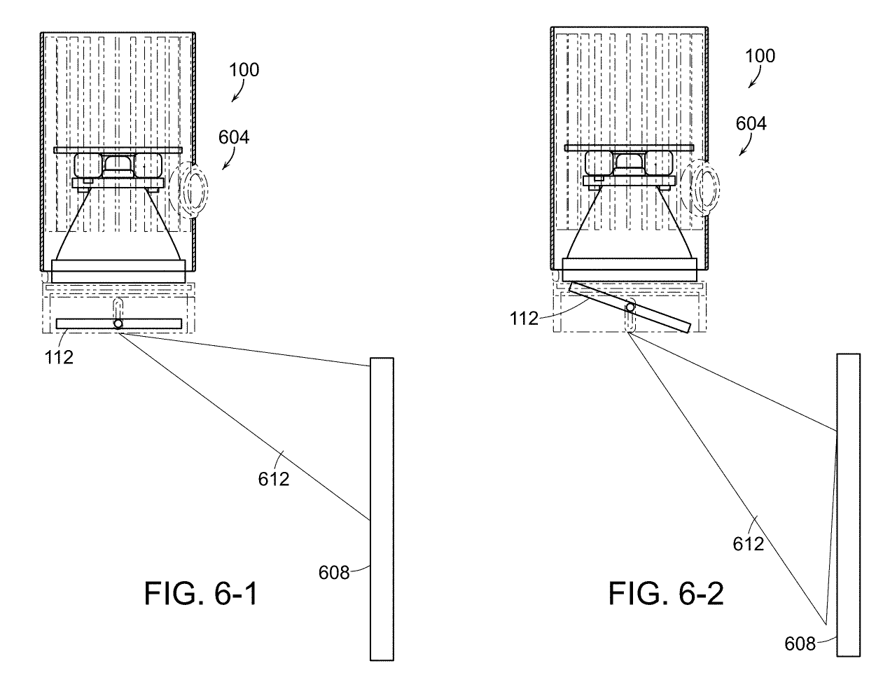

FIG. 8 is a lens and lens holder in accordance with an implementation of the present disclosure.

### DETAILED DESCRIPTION

In the following detailed description, numerous specific details are set forth in order to provide a thorough understanding of the aspects and implementations of the present disclosure. It will be understood by those of ordinary skill in the art that these may be practiced without some of these specific details. In other instances, well-known methods, procedures, components and structures may not have been described in detail so as not to obscure the implementations of the present invention.

It is to be understood that the details of construction and the arrangement of the components set forth in the following description or illustrated in the drawings are not limiting. There are other ways of being practiced or carried out. Also, it is to be understood that the phraseology and terminology employed herein are for the purpose of description only and also should not be regarded as limiting.

It is appreciated that certain features, which are, for clarity, described in the context of separate implementations, may also be provided in combination in a single implementation. Conversely, various features, which are, for brevity, described in the context of a single implementation, may also be provided separately or in any suitable sub-combination.

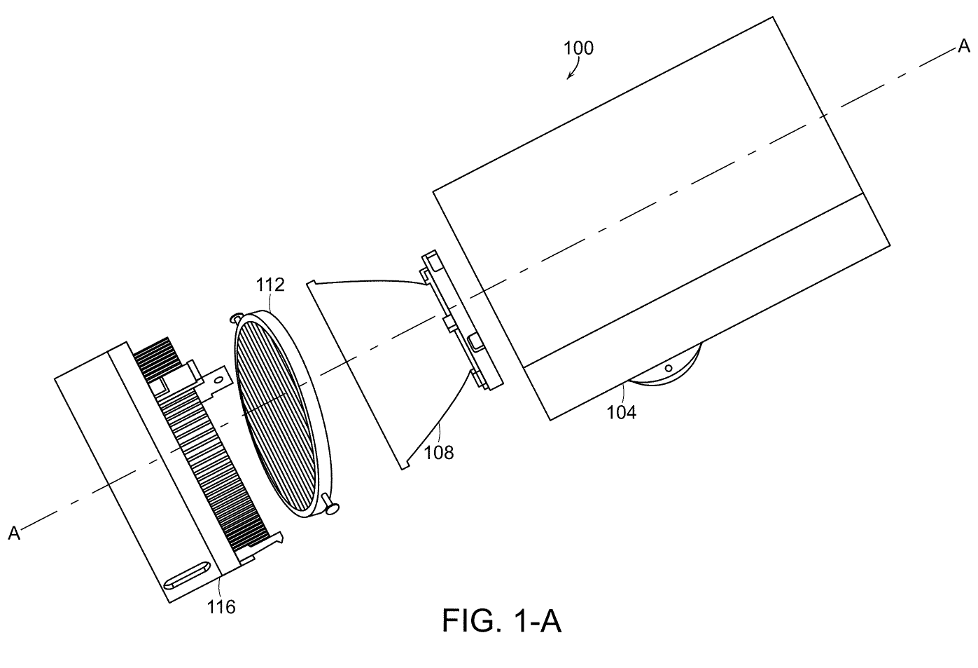

Referring now to FIGS. 1-A and 1-B, in one aspect of the present disclosure, a wall-washing lighting module 100 includes a fixture housing 104, a light engine 108, a lens 112 and a trim portion 116 and has a primary, or longitudinal, axis A-A. The fixture housing 104 and internal light engine 108 may be one such as is available from Lumenpulse of Montreal, Canada. The fixture housing 104 may be a hollow cylinder although implementations are not limited to a cylinder and could be, for example, an extruded rectangular prism, an elliptical extrusion, or the like. A “light engine” is defined as a light-emitting source, and in the implementation shown in FIGS. 1-A and 1-B, a primary optic. The primary optic, in other implementations, could be a clear optical material, reflector or other component, as is used in the trade.

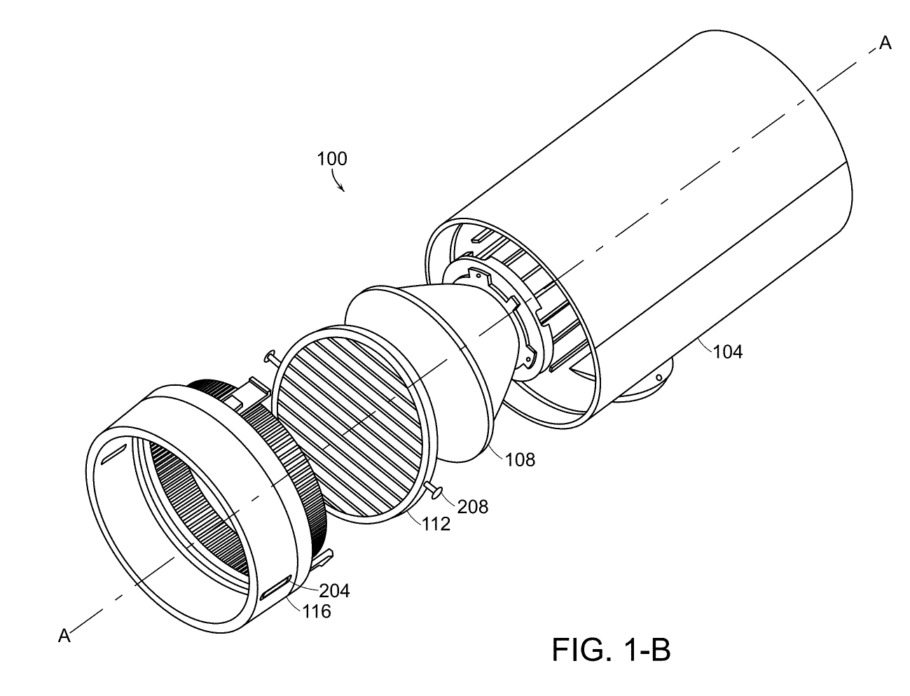

The lens 112 is concentrically provided in the trim portion 116 which is concentric with the fixture housing 104. As shown in FIG. 2, the trim portion 116 has two opposed slots 204 provided in the circumferential periphery. Two posts or pins 208 are sized to extend through the slots 204 and couple to the lens 112. The posts 208 include head portions 212 that allow for the posts to move within the respective slot 204. The slot 204 may be countersunk to allow the head portions 212 to be flush with the outer surface of the trim portion 116. Alternatively, the slots 204 could be recessed below the outer surface of the trim portion 116 to allow for an accessory cosmetic covering piece. The posts 208 may be screwed into lens 112 or attached by other methods as known to those of skill in the art. The slots 204 allow the lens 112 to travel linearly in a direction that is parallel to primary axis A-A of the module 100 and be rotated about an axis defined by the pins 208. This combination of rotation and linear translation allows for the lens 112 to be aimed for different vertical plane illumination applications, while preventing the lens from breaking the plane, i.e., extending out, of the module 100.

In one implementation of the disclosure, the slots 204 are a same length. Alternatively, the slots 204 may be of different lengths to provide a different range of angles and configurations.

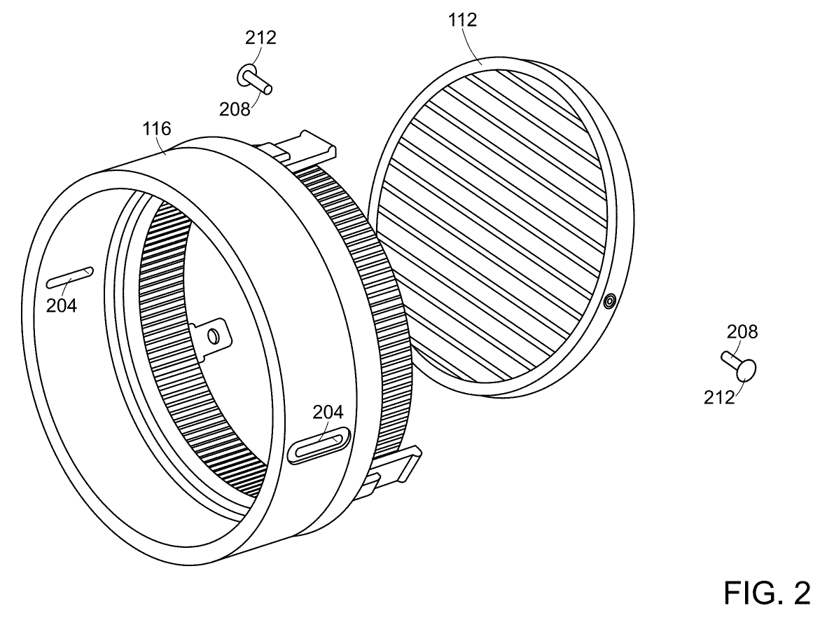

As shown in FIG. 3, the light source 108 is provided within the fixture housing 104 to direct light through the lens 112. The lens 112 can be moved along the length of the slot 204 and rotated. The location and angle of the lens 112 may be maintained by tightening the pins 208 if they are screwed in or there may be sufficient friction between the pin 208 and the slot 204 to maintain the angle and location. Other mechanisms known to those of ordinary skill in the art, e.g., a teething mechanism to hold a position in discrete angular increments, may be used.

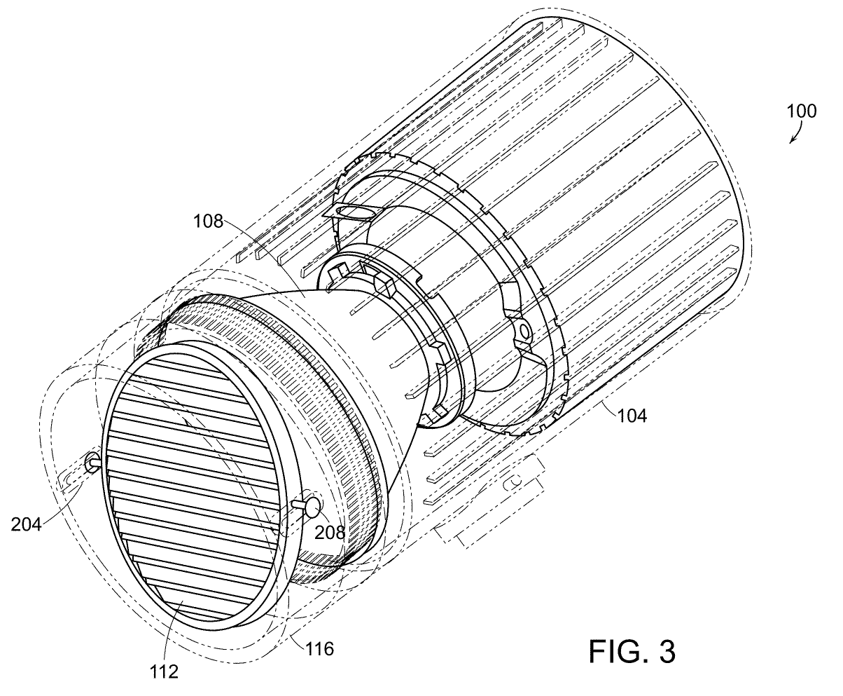

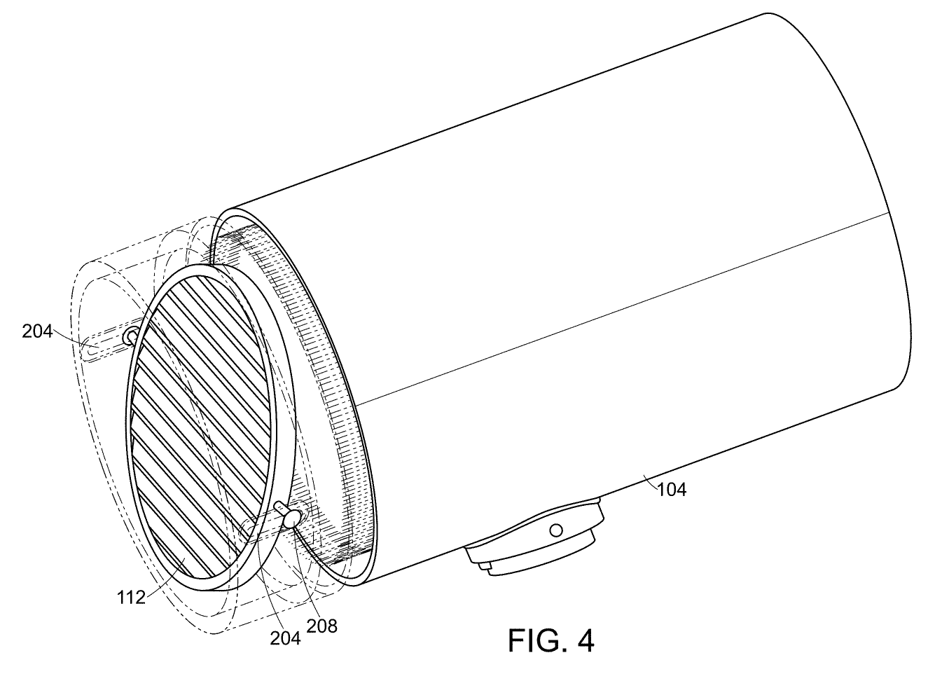

Referring to FIG. 4, the lens 112 and the length of the slot 204 are set such that the lens 112 can be angled and not extend from the trim portion 116 in order to provide an acceptable aesthetic design, as shown in FIG. 5 and in FIG. 17. By maintaining the lens 112 within the trim portion 116, potential visual discomfort created by glare that would result from an extending lens 112 is avoided and the aesthetics of any designed fixture lines are preserved.

The slots 204 are positioned, or set back, a same predetermined distance from the edge of the opening of the fixture housing 104 through which light is emitted in order to prevent the lens 112 from showing when set at an angle in one implementation. Alternatively, the slots 204 may be set back different distances to provide different angle combinations. The lens 112 is sized to fit within the aperture area, e.g., smaller than a minimum diagonal or hypotenuse or primary diameter dimension, for fixture housing bodies of non-circular shapes. One example of which is a circular lens rotating within the confines of a square trim piece.

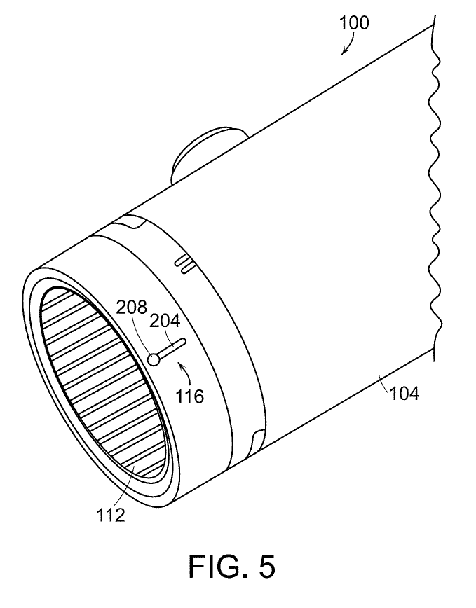

In one aspect of the present disclosure, different wall washing effects can be provided by adjusting an angle of the lens 112 as shown in FIGS. 6-1 AND 6-2. Generally, in this example, the module 100 is mounted in a ceiling portion 604 adjacent a target vertical plane surface 608. The angle of the lens 112 and the location of the lens 112 in the slot 204, e.g., closer to or farther from the light source 108, provides different wall wash effects 612, as shown. Of course, the module 100 may be floor mounted to provide uplighting as well as mounted horizontally to provide light across the surface. The configuration in which a module 100 is mounted with respect to the wall surface 608 is not a limitation of the aspects of the present disclosure.

In one aspect of the present disclosure, the lens 112 is a directional lens of optical material that directs light towards a target vertical plane in order to maximize even illumination. The lens 112, in one implementation, controls light through a combination of refraction and total internal reflection and may include a first lens surface 704 that is a linear spread face and a second lens surface 708 that is a directional cut face to spread light in both axes along a target vertical plane. Of course, one of ordinary skill in the art will understand that various types of lenses could be used.

The lens 112 is designed to achieve the most even illumination, as is possible, in a variety of orientations per known techniques. The lens design may be based around geometric dimensions of the linear spread components and directional cuts, optimized for a specific fixture type, size, or light source, as known to one of skill in the art.

A different lens design could achieve a different result as well. For example, a user may want a narrower or wider spread of light along the target plane, which would require a different lens to be used in the assembly.

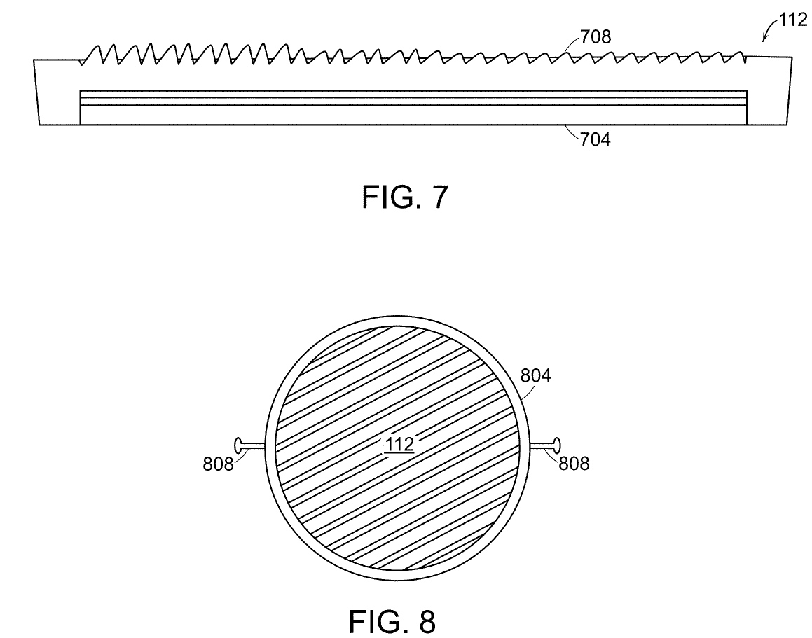

Further, another approach to providing the same degrees of freedom in translation and rotation of the lens 112 is envisaged. As shown in FIG. 8, a lens holder 804 for holding the lens 112 is used. The lens holder 804 has pins 808 to couple to the slots 204, as taught above. As a result, the lens 112 is free of any pins and could be removed from the assembly and replaced as needed, or for a different style lens to be placed into the fixture, for example, in the factory, in the field, etc. The lens 112 may be held in the lens holder 804 by, for example, an adhesive although one of ordinary skill in the art would understand that there are other ways to mount the lens 112 in the holder 804.

Additionally, in another implementation, the trim piece 116, including either the lens 112 and the pins 208, or the lens holder 804, is rotatably mounted to the fixture housing 104. Thus, the lens 112 can be rotated independently with respect to the fixture housing 104 about the housing primary axis A-A. Advantageously, additional flexibility for aiming the light is provided.

Still further, angle indicators or markings representing the angle at which the lens 112 is set, along with distance markings representing how far, or at what location, the lens 112 is placed in the slot 204, may be provided on an inner surface of the trim portion 116. These markings will allow for the settings, i.e., angle and distance, to be identified without a need for guessing and constant iteration. Further, the lighting effect can be more easily duplicated, if a series of modules 100 are used to light a surface by setting each one to the same angle and distance using the markings.

Still further, one or more structures may be provided to prevent the lens 112 from reaching a position that is beyond defined limits, for example, a 180° flip of the lens so that it is upside down in relation to the light source. One example of such a structure could be an extrusion placed on an inner surface.

A retrofitting kit comprising the trim portion 116 and lens 112 may be made available to attach to an existing light fixture to provide for the advantages of the system described herein.

Advantageously, the system described herein maximizes even illumination of a plane, for example, a vertical wall, in a variety of conditions having different vertical plane dimensions, target area, setback constraints, fixture orientation, etc. Additionally, this system provides a pleasing fixture aesthetic by keeping components inside the fixture housing.

It will be understood by those reasonably skilled in the arts that the techniques disclosed herein may be similarly applied to the design, manufacture and fabrication of other illuminating assemblies given the disclosure contained herein.

The present disclosure is illustratively described above in reference to the disclosed implementations. Various modifications and changes may be made to the disclosed implementations by persons skilled in the art without departing from the scope of the present disclosure as defined in the appended claims.

What is claimed is:

1. A lighting fixture, comprising:
a housing having a proximal end and a distal opening at a distal end;
a lens; and
means for slidably and rotatably coupling the lens to the housing.

2. The lighting fixture of claim 1, wherein the coupling means comprises:
first and second pins coupled to the lens.

3. The lighting fixture of claim 2, wherein the coupling means further comprises:
first and second longitudinal slots, defined in the fixture housing, respectively coupled to the first and second pins.

4. The lighting fixture of claim 1, wherein the coupling means comprises:
a lens holder containing the lens, the lens holder having first and second pins located on a periphery of the lens holder,
wherein each of the pins is coupled to the fixture housing.

5. The lighting fixture of claim 4, further comprising:
first and second longitudinal slots, defined in the fixture housing, respectively coupled to the first and second pins.

6. A lighting fixture portion, comprising:
a fixture housing having a longitudinal axis, a proximal end and a distal opening at a distal end;
first and second longitudinal slots, defined in the fixture housing, wherein the first and second longitudinal slots are parallel to the longitudinal axis of the fixture housing; and
a lens slidably coupled to the first and second slots.

7. The lighting fixture portion of claim 6, wherein the fixture housing is cylindrical.

8. The lighting fixture of claim 7, wherein the fixture housing is hollow.

9. The lighting fixture portion of claim 6, further comprising:
first and second pins coupled to the lens through a respective slot in the fixture housing.

10. The lighting fixture portion of claim 9, wherein each pin is in a friction fit with the respective slot.

11. The lighting fixture portion of claim 9, wherein each of the slots has a same predetermined length that is chosen such that the lens cannot be rotated to extend from the fixture housing when each of the first and second pins is located at a proximal end of the respective slot.

12. The lighting fixture portion of claim 9, wherein each of the first and second slots comprises a recessed portion and each of the first and second pins comprises a head portion to couple with the recessed portion of the respective slot.

13. The lighting fixture portion of claim 12, wherein each of the first and second pins is screwed to the lens.

14. The lighting fixture portion of claim 6, wherein the first and second slots have respective first and second slot lengths.

15. The lighting fixture portion of claim 14, wherein the first and second slot lengths are the same.

16. The lighting fixture portion of claim 6, further comprising:
a lens holder containing the lens, the lens holder having first and second pins located on a periphery of the lens holder,
wherein each of the pins is coupled to a respective fixture housing slot.

17. The lighting fixture portion of claim 6, wherein a distal end of each of the first and second slots is a same distance from the distal end of the fixture housing.

18. The lighting fixture portion of claim 6, wherein the lens is an optical lens comprising:
a first surface comprising a linear spread structure; and
a second surface comprising a directional cut structure.

19. A lighting fixture, comprising:
a fixture housing having a longitudinal axis, a proximal end, a distal end and an opening provided at the distal end;
a first slot, having a first predetermined slot length oriented parallel to the longitudinal axis, defined in the fixture housing;
a second slot, having a second predetermined slot length oriented parallel to the longitudinal axis, defined in the fixture housing, wherein the second slot is located opposite the first slot about a periphery of the fixture housing; and
a lens movably coupled to the first and second slots.

20. The lighting fixture of claim 19, further comprising:
first and second pins coupled to the lens through a respective fixture housing slot.

21. The lighting fixture of claim 20, wherein each pin is friction fit with the respective slot.

22. The lighting fixture of claim 20, wherein each of the slots has a same length that is chosen such that the lens cannot be rotated to extend from the fixture housing when each of the first and second pins is located at a proximal end of the respective slot.

23. The lighting fixture of claim 20, wherein each of the first and second slots comprises a recessed portion and each of the first and second pins comprises a portion to couple with the recessed portion of the respective slot.

24. The lighting fixture of claim 23, wherein each of the first and second pins is threadably coupled to the lens.

25. The lighting fixture of claim 20, wherein the lens is circular and comprises a diameter that is less than an inner diameter of the distal opening of the fixture housing.

26. The lighting fixture of claim 25, wherein the first and second pins are disposed 180° from one another about a circumference of the lens.

27. The lighting fixture of claim 19, further comprising:
a lens holder containing the lens, the lens holder having first and second pins located on a periphery of the lens holder,
wherein each of the pins is coupled to a respective fixture housing slot.

28. The lighting fixture of claim 27, wherein each pin is friction fit with the respective slot.

29. The lighting fixture portion of claim 19, wherein the fixture housing is cylindrical.

30. The lighting fixture portion of claim 29 wherein the first and second slots are positioned 180° from one another about the circumferential periphery of the fixture housing.

31. The lighting fixture of claim 19, further comprising:
a light source disposed in the fixture housing to direct a light beam toward the distal opening of the fixture housing.

32. The lighting fixture of claim 19, wherein the first and second predetermined slot lengths are the same.

33. The lighting fixture of claim 19, wherein a distal end of each of the first and second slots is a same distance from the distal end of the fixture housing.

34. The lighting fixture of claim 19, wherein the lens is an optical lens comprising:
a first surface comprising a linear spread structure; and
a second surface comprising a directional cut structure.
